(19) United States
(12) Patent Application Publication
(10) Pub. No.: US 2020/0110628 A1
(43) Pub. Date: Apr. 9, 2020

(54) Container and Virtual Machine and Software Instance Scheduler in Cloud Radio Access Network

(71) Applicant: DIGIMETRIK LLC, Reston, VA (US)

(72) Inventor: VOLKAN SEVINDIK, Reston, VA (US)

(73) Assignee: DIGIMETRIK LLC, Reston, VA (US)

(21) Appl. No.: 16/590,479

(22) Filed: Oct. 2, 2019

Related U.S. Application Data
(60) Provisional application No. 62/766,208, filed on Oct. 5, 2018.

(51) Int. Cl. G06F 9/455; G06F 9/48; G06F 9/50

(52) U.S. Cl. CPC G06F 9/45558; G06F 9/4881; G06F 9/505; G06F 2009/45575; G06F 2009/45595; G06F 2009/45591; G06F 2009/4557

(57) ABSTRACT

A cloud radio access network has a radio access network to run all base band functions on commercial of the shelf hardware with virtualization. Virtualized network functions run on virtual machines and on software containers. Some network functions have very strict data transmission latency, throughput, bit error rate, security, block error rate, service quality, experience quality, traffic, requirements that these virtualized network functions satisfy. A method employs container and virtual machine technologies with selecting the right technology with a container virtual machine (CVM) scheduler and a software instance (SI) scheduler.

### CROSS-REFERENCE TO A RELATED APPLICATION

This application claims the benefit of U.S. Provisional Application Ser. No. 62/766,208 filed on Oct. 10, 2018, the disclosure of which is hereby incorporated by reference in its entirety, including all figures, tables and drawings.

### BACKGROUND OF THE INVENTION

FIG. 1 shows a CRAN comprising a container, virtual machine, and software instance scheduler, according to an embodiment of the invention.

### BRIEF SUMMARY OF THE INVENTION

A embodiment of the invention is directed to a telecommunication system comprising a plurality of virtualized base band functions of a telecommunication standard, at least one software system for running each of the virtualized functions, a hardware system for running the software system, at least one virtual machine that executes at least one set of functions of the telecommunication standard, at least one software container for executing at least one set of the base band functions, at least one container or virtual machine scheduler for selecting between the virtual machine, the container, or both for scheduling at least one of the set of functions of the telecommunication standard, and at least one software instance scheduler for selecting at least one instance of the virtual machine, the container, or both. The virtualized base band functions further comprise at least one data processing layer defined in the telecommunication standard. A software system can include one or more of a hypervisor, an operating system, a hardware driver software, a programming software, a test software, at least one software running virtual instance, a virtual machine software, a virtual machine load management software, a virtual machine resource usage monitoring software, a container software, a container resource usage monitoring software, a container load management software, a container orchestrator software, a resource management software, and a port management software. The hardware system can include at least one of: a memory unit; a central processing unit; a controller unit; a graphical processing unit; one or more ports; one or more hardware boards; one or more cables; and one or more converters; and any other hardware component. The at least one virtual machine comprises a software system executing task or a set of tasks. The at least one container further comprises a software system executing task or a set of tasks. The at least one virtual machine container scheduler further comprises a software system for executing task or a set of tasks. The at least one software instance scheduler can include a software system for executing a task or a set of tasks.

An embodiment of the invention is directed to a method of virtual machine container scheduling by analyzing a load level of at least a portion of at least one virtual machine and/or container instance, analyzing at least one requirement of data transmission latency selected from: data throughput; data error rate; data service quality; data subscriber experience quality; data block error rate; data security of at least a portion of functions of at least one data processing layer, and selecting at least one of the at least one virtual machine and/or container to run at least one function of at least one data processing layer. The method can include determining hardware and software resources consumed by at least one virtual machine and/or container software. The method can include determining energy resources consumed by at least one virtual machine and/or container software. The method can include performing measuring and monitoring in a container software load consumption measurement and monitoring software, wherein the container software load consumption measurement and monitoring software is a portion of a container software system or is software other than the container software system. The method can include performing measuring and monitoring in a virtual machine software load consumption measurement and monitoring software, wherein the virtual machine software load consumption measurement and monitoring software is a portion of a virtual machine software system or is software other than the virtual machine software system. The method can include reading layer information file comprising: a layer name; a layer number; a layer data transmission latency requirement; a layer data throughput requirement; a previously run container number; a previously run virtual machine number; an upper layer served by a layer, and a lower layer served by a layer. The method can include analyzing inputs selected from: data processing layer information; virtual machine information; container information; virtual machine instances; container instances; technology; backhaul type; fronthaul type; location; hardware operating system; hypervisor; and priority table. Analyzing input can include creating profiles for the at least one at least one virtual machine and /or container instance within at least one of a container software and a virtual machine software, employing at least one of: running protocol layer information, resource consumption information, error information, quality of service information, data communication performance information, hardware performance information, and software performance information. The method can include profiling the performance of at least one container instance in at least one container software performance profiler. The method can include profiling the performance of at least one virtual machine instance in at least one virtual machine software performance profiler.

An embodiment of the invention is directed to a method of software instance scheduling via a software instance scheduler by analyzing a load level of at least one of at least one virtual machine software and/or container software instance and selecting at least one most suitable virtual machine software and/or container software instances to execute at least a portion of one or more data processing layer functions. The method can include reading a virtual machine or container instance identification file that contains a virtual machine or container instance name, a virtual machine or container instance identification number, identity of a layer processed in a virtual machine or container instance, an operating system type, an operating system release number, a resource usage, a performance, and a container type.

### BRIEF DESCRIPTION OF THE DRAWINGS

FIG. 1 is a scheme of a Cloud Radio Access Network (CRAN) that includes hardware and software components to perform functions of a telecommunication standard where telecommunication standard features are virtualized and run inside at least one of a virtual machine and a container, according to an embodiment of the invention.

FIG. 2 shows a scheme for general hardware and software architecture of cloud radio access network runs on traditional commercial of the shelf hardware, according to an embodiment of the invention.

FIG. 3 shows the layered architecture of any telecommunication standard.

FIG. 4 shows the contents of a layer information file for each data processing layer of the telecommunication standard.

FIG. 5 shows a flow chart for the decision mechanism of the CVM scheduler, according to an embodiment of the invention.

FIG. 6 shows a list of the fields contents of a layer information file for each container instance identification file.

FIG. 7 shows a chart of the inputs to a CVM Scheduler used to make decisions about virtual machine selection and container selection.

FIG. 8 shows a priority table used by a CVM Scheduler.

FIG. 9 shows a container resource usage indicator function for a container's consumption of hardware resources to execute its tasks.

FIG. 10 shows a virtual machine resource usage indicator function for a virtual consumption of hardware resources to execute its tasks.

FIG. 11 shows a chart for the container or virtual machine instance versus a data processing layer performance where performance monitoring software monitors the current performance and holds past performance data versus time.

FIG. 12 shows charts for possible connectivity of a container resource usage monitor and virtual machine resource usage monitor to the corresponding container and virtual machine.

FIG. 13 shows a chart for a container and its related container resource usage monitor, consumed hardware resources calculation, consumed software resources calculation, and consumed energy resources calculation.

FIG. 14 shows a chart for a virtual machine and its related virtual machine resource usage monitor, consumed hardware resources calculation, consumed software resources calculation, and consumed energy resources calculation.

FIG. 15 shows a virtual machine connected to its container load consumption measurement and monitoring.

FIG. 16 shows a container connected to its container load consumption measurement and monitoring.

FIG. 17 shows a chart of a container performance profiler that creates performance reports for each container instance that is running.

FIG. 18 shows a chart of a virtual machine performance profiler that creates performance reports for each virtual machine instance that is running.

FIG. 19 shows a container profiler and a virtual machine profiler with a communication interface between the container profiler and the virtual machine profiler.

### DETAILED DESCRIPTION OF THE INVENTION

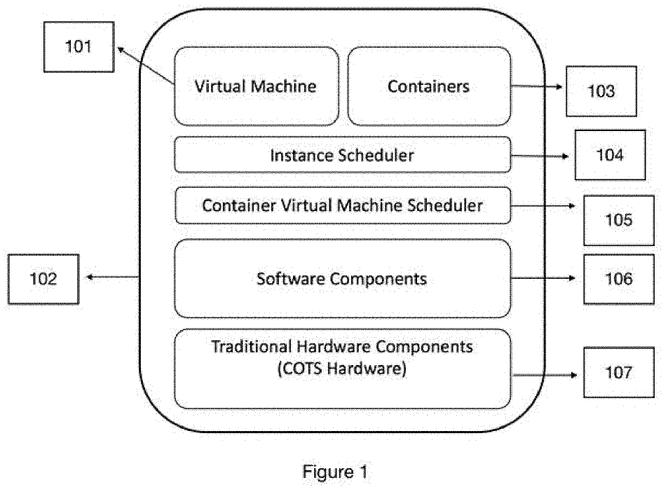

As shown in FIG. 1 Cloud Radio Access Network (CRAN) 102 that includes hardware 107 and software 106 components required to perform functions by any telecommunication standard. Hardware components 107 can be any commercial off-the-shelf (COTS) hardware components. Software components 106 include, but are not limited to, hypervisors, operating systems, and software components that are traditional and/or non-traditional. All telecommunication standard features are virtualized and run on COTS hardware. Virtualized components are software components that run inside a virtual machine 101 and/or inside a container 103. The virtual machine 101 and the container 103 have different performance in terms of boot-time, memory management, resource sharing, run-time performance, certain access methods to certain feature or features of an underlying operating system, and other performance and security related functions, features, and methods. Software container is referred to as a container and the terms are interchangeable herein. Similarly, a software virtual machine is referred to as a virtual machine and the terms are interchangeable herein.

The telecommunication standard consists of several different layers that perform specific tasks to perform communication between a receiver and a transmitter. Each layer of telecommunication standard executes certain functions that need equal or different amounts of hardware and software resources. Task that a telecommunication layer performs is at least one of signal processing, data processing, encoding, decoding, channel coding, channel decoding, modulation, demodulation, compression, decompression, antenna mapping, layer mapping, serial to parallel conversion, parallel to serial conversion, data analysis, classification, machine learning algorithms, fronthaul communication, midhaul communication, backhaul communication, data transmission over a ethernet, data transmission over fibers, data transmission over any wireless or radio frequency (RF) environment, and data transmission over a microwave environment.

Container Virtual Machine (CVM) scheduler 105 makes decisions to initiate and to execute certain functions of a layer of telecommunication standard either in the virtual machine 101 or the container 103. CVM scheduler 105 makes decisions to initiate and execute some functions of the same processing layer in the container and to initiate and execute some functions of the same processing later in the virtual machine. The CVM scheduler 105 makes decisions to initiate and execute all functions of the same processing layer in the container 103 or the CVM scheduler 105 makes decisions to initiate and execute all functions of the same processing layer in the virtual machine 101. In a cloud environment, there will be more than one instance of the virtual machine 101 and the container 103 running at the same time. Each of the virtual machine 101 and container 103 instances has different amounts of processing load. Software instance scheduler 104 selects the best instance(s) of virtual machine 101 and container 103 to run the functions of the processing layer.

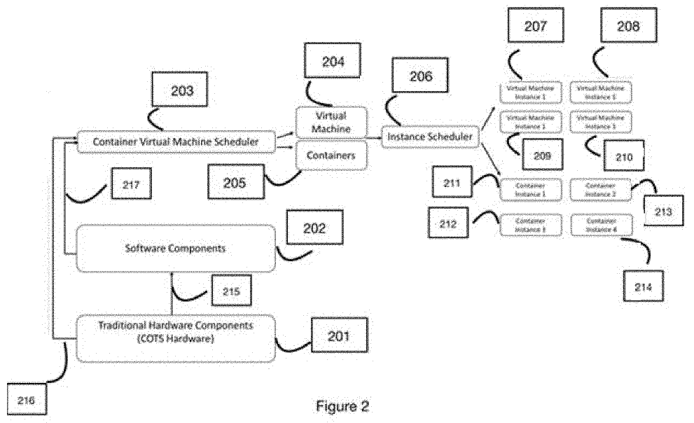

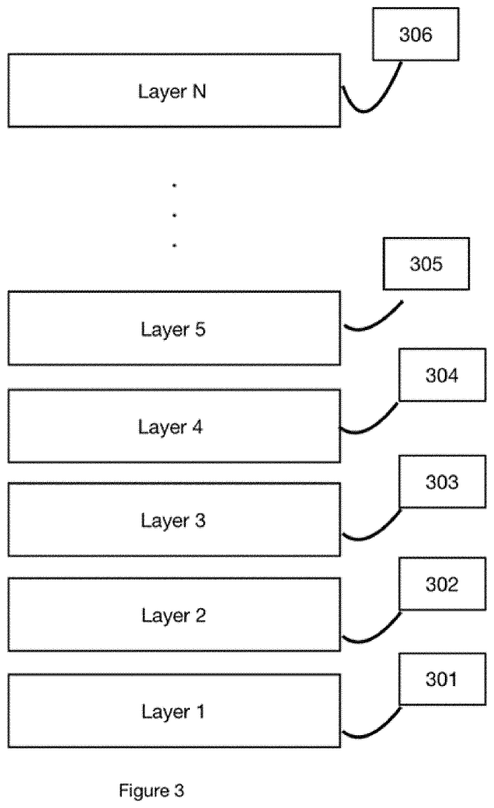

FIG. 2 shows a general hardware and software architecture where the Cloud radio access network runs on traditional commercial of the shelf hardware (COTS) 201. On the top of COTS hardware there are software components 202, running that use COTS hardware resources required for all processing, data communication, resource management, and any other processes of the cloud radio access network. Container virtual machine scheduler 203 makes decision on one or both of the virtual machine software 204 or the container software 205, which should be used to run certain or all processes of certain data processing layer 301, 302, 303, 304, 305, and 306, as indicated in FIG. 3. CVM scheduler makes decision using inputs 216 and 217 from at least one of the COST hardware 201 and software components 202. The instance scheduler (software instance scheduler) 206 selects the most appropriate software instance 207, 208, 209, and 210 of virtual machine 204 or software instance 211, 212, 213, and 214 of software container 205, or both the container 205 and virtual machine 204 when either of virtual machine 204 or container 205 is selected to run certain processes belonging to a certain layer or layers of the standard.

Since telecommunication standard functions, 300 require certain data transmission latency, data throughput, and data security performance; these functions should be run in the most suitable software environment, and in the most suitable software instance inside that software environment. FIG. 3 shows the layered architecture of any telecommunication standard. Each layer 301, 302, 303, 304, 305, and 306 is dedicated to a certain type of a task.

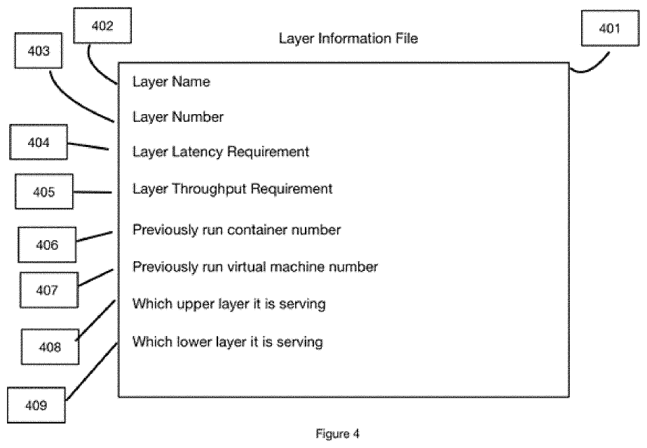

As shown in FIG. 4, each data processing layer of the telecommunication standard has a layer information file, 401. Each layer has a layer name 402, a layer number 403, a layer latency requirement 404, a layer throughput requirement 405, a layer bit error rate requirement, a layer block error rate requirement, a layer quality of service requirement, layer quality of experience requirement, a layer security requirement, a previously run container instance number 406, a previously run virtual machine instance number 407, which upper data processing layer it is serving 408, and which lower data processing layer it is serving 409.

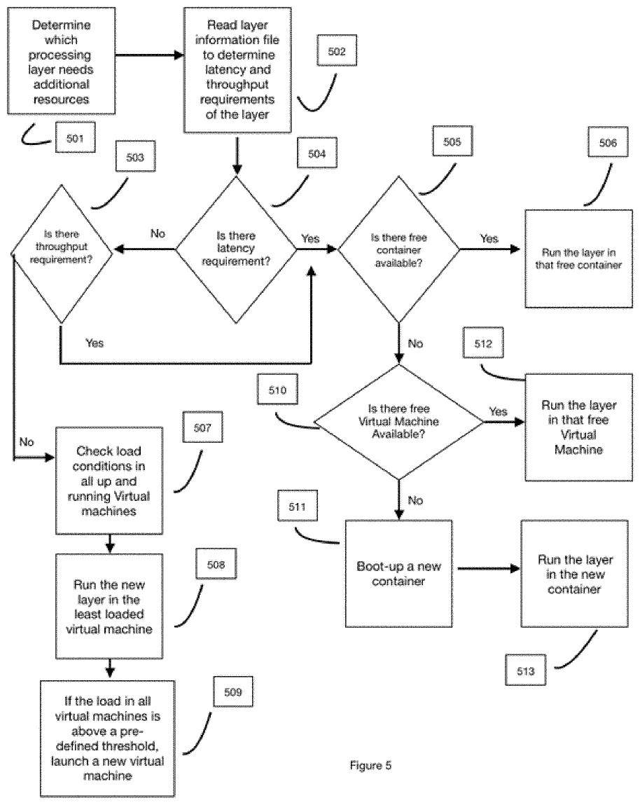

FIG. 5 shows the decision mechanism for the CVM scheduler 105, 203. First, the CVM scheduler determines which data processing layer needs additional resources to satisfy its promised performance levels, 501. Layer information file of the data processing layer is read by CVM to determine at least one of the data transmission latency, targeted data throughput values, security requirements, bit error rate requirements, block error rate requirements, service quality requirements, and the quality of user experience requirements, 502. If there is data transmission latency requirement, the CVM checks if there is any free container 505 available with available resources to run the required data processing layer functions at promised performance levels. If there is such availability of a container 505, the data processing layer is run in that container, 506. If there is no container available, the CVM checks if there is any free virtual machine 510 available. If there is a virtual machine available to run all the functions of the data processing layer, then the data processing layer is run in the virtual machine 512. If no virtual machine is available to run all the functions of the data processing layer, a new instance of software container is initiated in real-time, and all the functions of data processing layer is run in this new container.

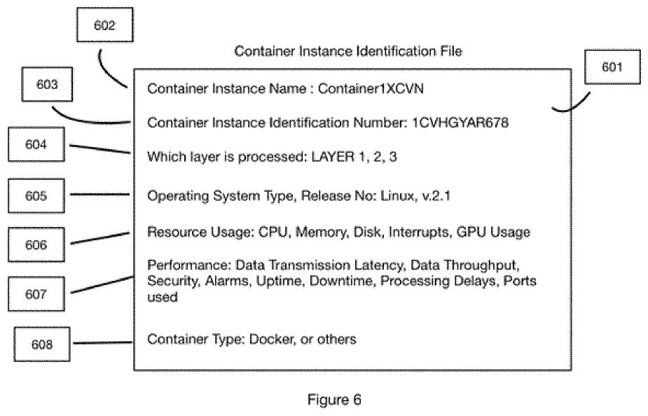

Each container has a container instance identification file 601. FIG. 6 shows an example for fields used in container instance identification file 601. Each container instance has container instance name 602, a container instance identification number 603, which layer is being executed 604 in the container, an operating system type and operating system release no 605, a resource usage 606, a performance 607, and container type 608.

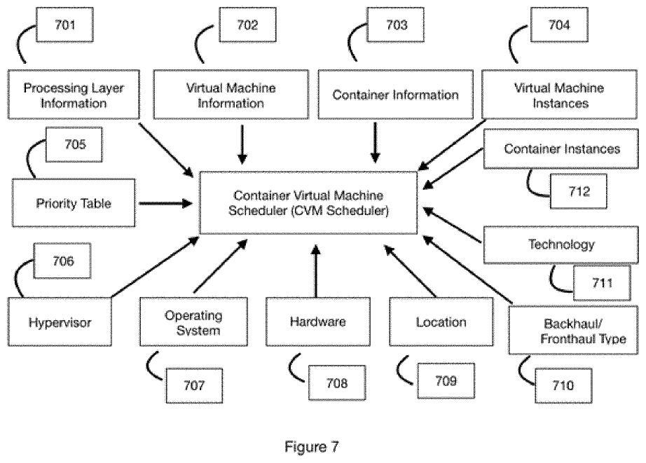

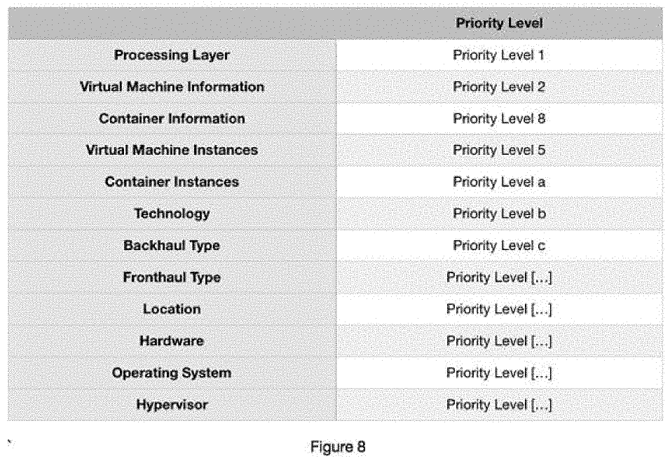

FIG. 7 shows inputs to a CVM Scheduler. The CVM scheduler uses at least one of these inputs to make decisions about virtual machine selection, container selection or both virtual machine and container selection. The inputs include: processing layer information 701, which is the processing layer defined in a technology or telecommunication network standard; virtual machine information 702, which is information about at least one of the virtual machines in the system; container information 703, which is information about at least one of the containers in the system; virtual machine instant 704, which is information about at least one virtual machine instances; priority table 705, which is a priority table, as shown in FIG. 8; hypervision 706, which is information about hypervisor; operating system 707, which is information about operating system; hardware 708, which is information about the hardware running in the system; location 709, which is the location information of where the possible radio access network is running, and/or located; information about backhaul, midhaul, and fronthaul types 710; information about technology functions and features 711, which is being virtualized in cloud environment; and information about container instances 712.

FIG. 8 shows a priority table that the CVM Scheduler uses. This priority table gives different priority weighting to input parameters during decision making process, where the higher the priority level of an input parameter, the higher the importance given to that input parameter. Input parameters are combined in any order through any calculation method. Priority levels can be any alphanumeric number. The processing layer is the protocol layer of a telecommunication standard which is responsible to perform a task, or set of tasks. Virtual machine information is the information about a virtual machine, or a set of virtual machines. Container information concerns the information about a container, or a set of containers. Virtual machine instances are the instances of virtual machines running. Container instances are instances of containers running. Technology is a software technology user in a virtual machine, a container, and software and hardware technology used in cloud radio access system. Backhaul type is the type of backhaul connection used between cloud radio access network and core network. Fronthaul type is the type of fronthaul connection used between radios and cloud radio access network. Location is where a cloud radio access network is placed geographically. Hardware is the type, model, age, speed, communication capability, memory capability of the hardware components used in the cloud radio access network. Operating system is the type of operating system, release of operating system, capabilities of operating system, and capacity of the operating system. Hypervisor is the type, model, release version of a hypervisor used in cloud radio access network.

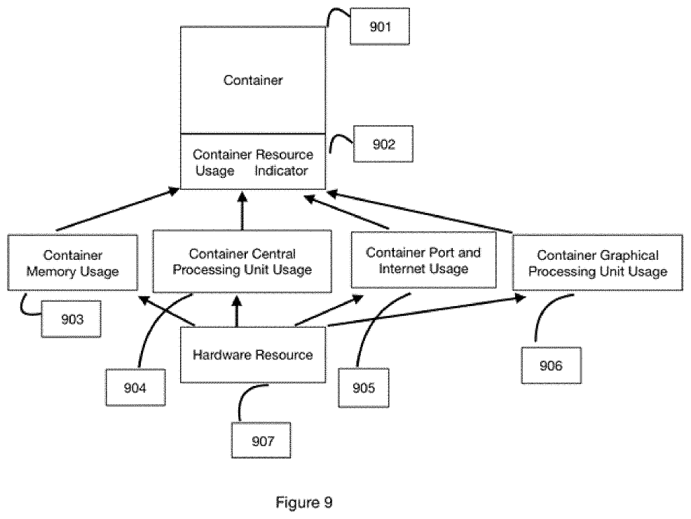

FIG. 9 shows container resource usage indicator function 902. Container 901 consumes hardware resources 907 to execute its tasks. Container consumes memory, and this is indicated by container memory usage 903. Container 901 consumes central processing unit resources, and this is indicated by container central processing unit usage 904. Container consumes port resources and internet resources consumed for communication is indicated by container port and internet usage, 905. Container consumes graphical processing unit resources is indicated by graphical processing unit resource usage 906. Container resource usage indicator uses at least one of memory usage 903, central processing unit usage 904, port and internet usage 905, and graphical processing unit usage 906 in order to calculate consumed resources by the container. Any hardware and software resources used by a container is stored and recorded in a container resource usage indicator. The container resource usage indicator is part of container, or the container resource usage indicator runs in a different hardware and software environment which is communicated with the container to receive all load related functions.

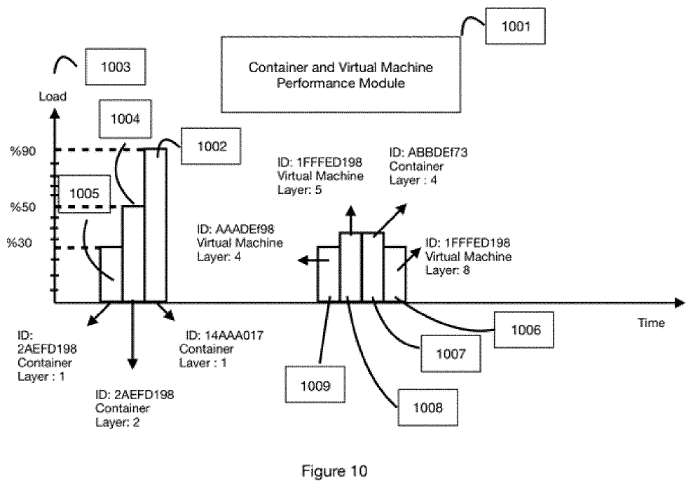

FIG. 10 shows virtual machine resource usage indicator function 2002. Virtual machine 2001 consumes hardware resources 2007 to execute its tasks. Virtual machine consumes memory, and this is indicated by container memory usage 2003. Virtual machine 2001 consumes central processing unit resources, and this is indicated by container central processing unit usage 2004. Container consumes port resources and internet resources consumed for communication is indicated by container port and internet usage, 2005. Container consumes graphical processing unit resources is indicated by graphical processing unit resource usage 2006. Container resource usage indicator uses at least one of memory usage 2003, central processing unit usage 2004, port and internet usage 2005, and graphical processing unit usage 2006 in order to calculate consumed resources by the container. Any hardware and software resources used by a container is stored and recorded in a container resource usage indicator. The container resource usage indicator is part of container, or the container resource usage indicator runs in a different hardware and software environment which is communicated with the container to receive all load related functions.

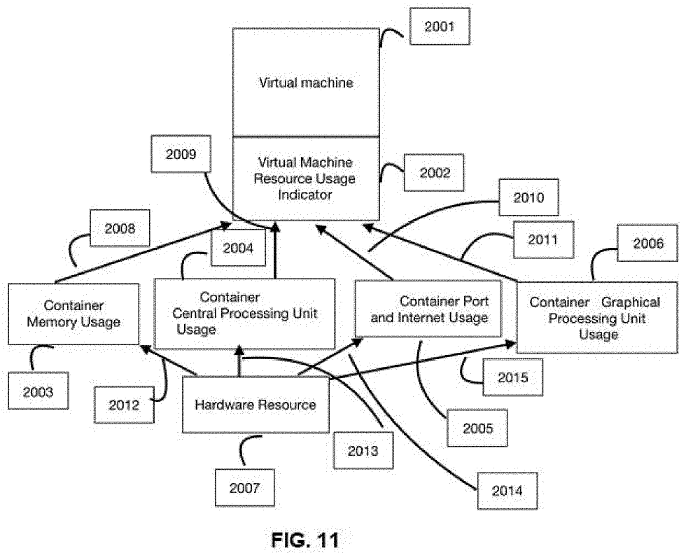

FIG. 11 shows a container or virtual machine instance versus a data processing layer performance 1001. This performance monitoring software monitors the current performance and holds past performance data versus time. Plot 1003 shows the load level in every instance of a container and in every instance of a virtual machine. Each data processing layer is mapped to a particular instance of a container 1002, 1004, 1005, and 1007 or to a particular instance of a virtual machine 1009, 1008, and 1006 or both. A container instance load 1005 is shown for running all of functions of layer 1 of technology standard. A load of the same container (with the same ID) instance 1004 is shown for running all of functions of layer 2 of technology standard after some time. An instance of a virtual machine 1008 is shown for running all of functions of layer 5. The same virtual machine instance (same ID) 1006 runs all of the functions of layer 8.

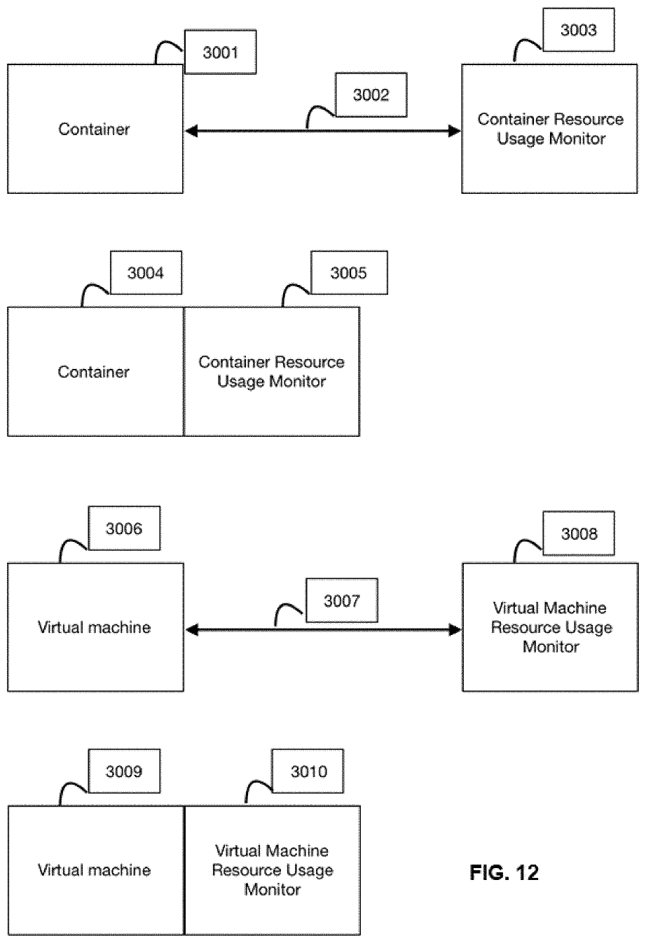

FIG. 12 shows that container resource usage monitor, 3005, can be part of container software, 3004. Container resource usage monitor 3003 can be connected to container software 3001, through an interface 3002. The interface 3002 can be any kind of communication interface which uses any kind of communication protocol. On this interface 3002 communication is performed with application programming interfaces. FIG. 3000 shows a virtual machine 3006, a virtual machine resource monitor 3008, and a communication interface 3007 between virtual machine and virtual machine resource monitor. The interface 3007 can be any kind of communication interface which uses any kind of communication protocol. On this interface 3007, communication is performed with application programming interfaces. Virtual machine 3009 is shown coupled to virtual machine resource usage monitor 3010.

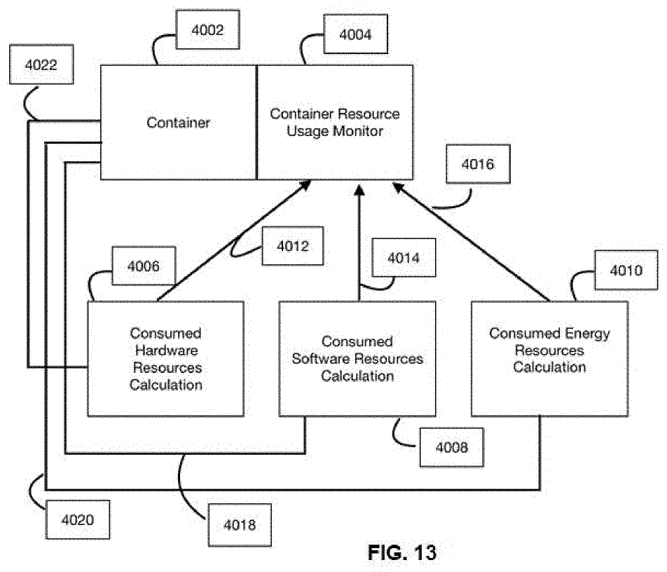

FIG. 13 shows a container 4002, its container resource usage monitor 4004, consumed hardware resources calculation 4006, consumed software resources calculation 4008, and consumed energy resources calculation 4010. Container resource usage monitor 4004 measures the amount of resources consumed by container. The consumed hardware resources calculation 4006 for the container is calculated based on any physical and virtual hardware resources consumed to run the container, and to run all software inside a container. Software Resources 4008 shows is the resources consumed by the container that is calculated based on any real and virtual software resources consumed to run a container, and to run all software inside a container. The energy consumed 4010 to run a container and to run all software inside a container is calculated. Communication between the container, the consumed hardware resources calculation, the consumed software resources calculation, and the consumed energy resource calculation are indicated by 4018, 4020, and 4022. Components 4006, 4008, and 4010 report all consumed hardware, software and energy resources to container resource usage monitor 4004.

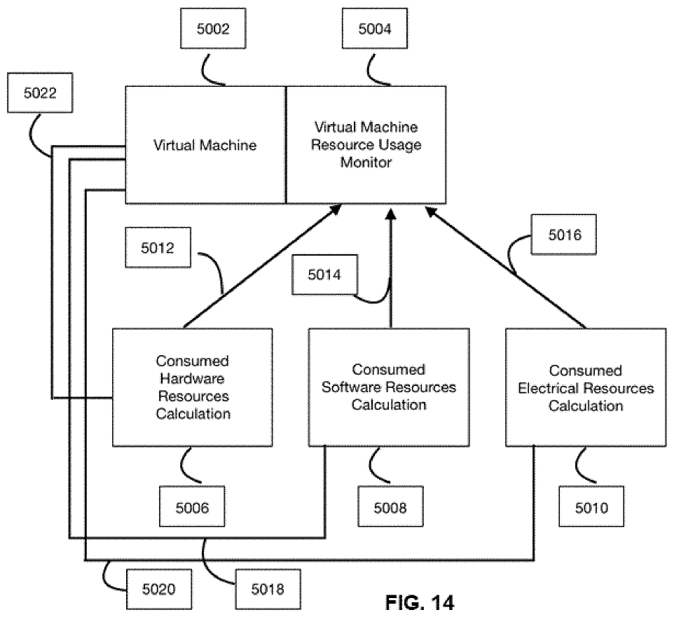

In like manner, FIG. 14 shows a virtual machine 5002, its virtual machine resource usage monitor 5004, and the accompanying consumed hardware resources calculation 5006, consumed software resources calculation 5008, and consumed energy resources calculation 5010. The virtual machine resource usage monitor 5004 measures the amount of resources consumed by virtual machine. Hardware resources calculation 5006 of resources consumed by virtual machine is calculated based on any physical and virtual hardware resources consumed to run a virtual machine, and to run all software inside a virtual machine. Software resources calculation 5008 of resources consumed by virtual machine is calculated based on any real and virtual software resources consumed to run a virtual machine, and to run all software inside a virtual machine. Energy consumed calculation 5010 is that required to run a virtual machine and to run all software inside a virtual machine. Communication between virtual machine, consumed hardware resources calculation, consumed software resources calculation, and consumed energy resource calculation are indicated by 5018, 5020, and 5022. All consumed hardware, software and energy resources from 5006, 5008, and 5010 are reported to the virtual machine resource usage monitor, 5004.

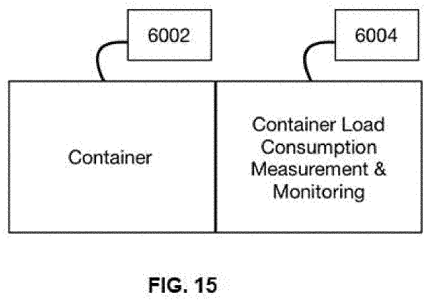

FIG. 15 shows a container 6002 and its container load consumption measurement and monitoring 6004. Container load consumption measurement and monitoring can be part of the container software, or the container load consumption measurement and monitoring can be placed and run in a different software environment than the software environment of container.

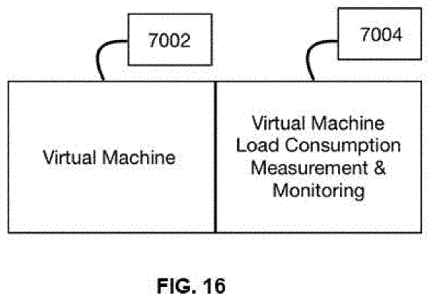

FIG. 16 shows a virtual machine 7002 and its virtual machine load consumption measurement and monitoring 7004. Virtual machine load consumption measurement and monitoring can be part of the virtual machine software, or the virtual machine load consumption measurement and monitoring can be placed and run in a different software environment than the software environment of virtual machine.

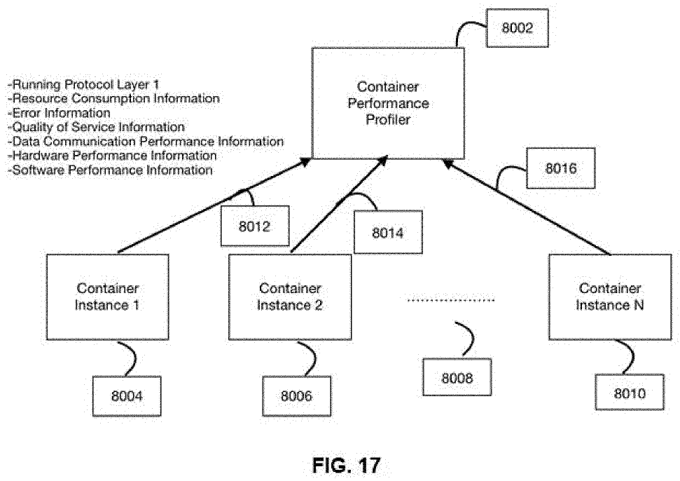

FIG. 17 shows a container performance profiler 8002 that creates a performance report for each container instance running. Container instance 1, 8004, container instance 2, 8006, and container instance N, 8010, report running protocol layer, resource consumption information, error information, quality of service information, data communication performance information, hardware performance information, and software performance information. Container instance and container profiler communicate over interfaces 8012, 8014, and 8016. The container profiler creates a table that shows: the performance of a container instance based on a protocol layer of communication standard that the container is running; resource consumption information which shows all hardware; software and energy resources container consumes; error information, which shows all past and real-time errors regarding the container itself; hardware container uses; software container uses; the quality of service information which shows if container instance is able to provide required service quality levels to all processes it is running; hardware performance information that shows the past and real-time performance of real and virtual hardware resources that container consumes; and software performance information shows the past and real-time performance of all real and virtual software resources that the container consumes.

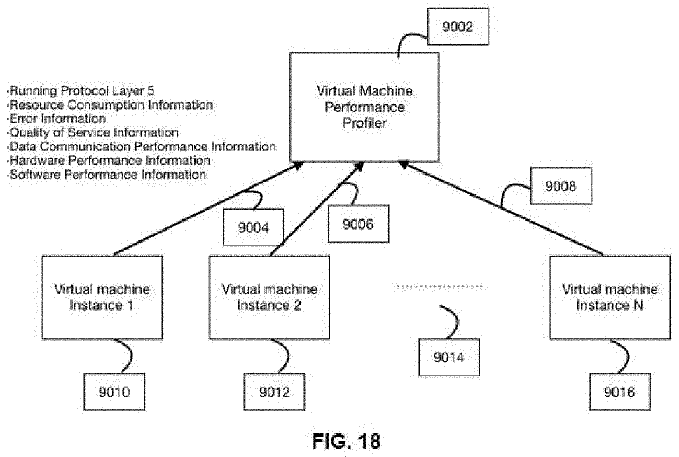

FIG. 18 shows a virtual machine performance profiler 9002, which create performance report for each virtual machine instance running. Virtual machine instance 1, 9010, virtual machine instance 2, 9012 and virtual machine instance N, 9016 report running protocol layer, resource consumption information, error information, quality of service information, and data communication performance information, Hardware performance information, software performance information. The virtual machine instance and the virtual machine profiler communicate over interfaces 9004, 9006, and 9008. The virtual machine profiler creates a table that shows: the performance of a virtual machine instance based on a protocol layer of communication standard that the virtual machine is running; resource consumption information which shows all hardware, software, and energy resources the virtual machine consumes; error information, which shows all past and real-time errors regarding virtual machine itself; hardware virtual machine uses; software virtual machine uses; quality of service information, which shows if virtual machine instance is able to provide required service quality levels to all processes it is running; hardware performance information that shows the past and real-time performance of real and virtual hardware resources the virtual machine consumes; and software performance information, which shows the past and real-time performance of all real and virtual software resources that virtual machine consumes.

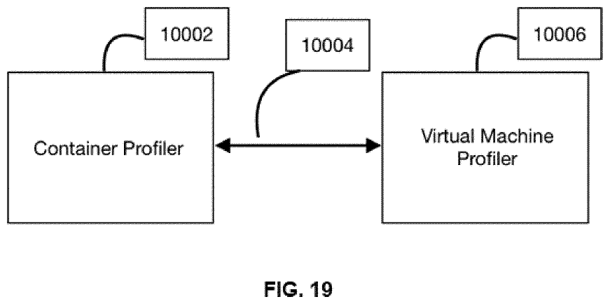

FIG. 19 shows a container profiler 10002, a virtual machine profiler 10006, and a communication interface 10004 between them. Container profiler and virtual machine profiler share information about container and virtual machines instances. In this way, both contain and virtual machine profiler are aware of which container and virtual machines instances perform most efficiently of all container and virtual machine instances.

It should be understood that the examples and embodiments described herein are for illustrative purposes only and that various modifications or changes in light thereof will be suggested to persons skilled in the art and are to be included within the spirit and purview of this application.

I claim:

1. A telecommunication system comprising:
a plurality of virtualized base band functions of a telecommunication standard;
at least one software system for running each of the plurality of virtualized functions;
a hardware system for running the at least one software system;
at least one virtual machine for executing at least one set of functions of the telecommunication standard;
at least one software container for executing at least one set of the base band functions;
at least one container or virtual machine scheduler for selecting between the virtual machine, the container, or both for scheduling at least one of the set of functions of the telecommunication standard; and
at least one software instance scheduler for selecting at least one instance of the virtual machine, the container, or both.

2. The telecommunication system of claim 1, wherein the virtualized base band functions further comprise at least one data processing layer defined in the telecommunication standard.

3. The telecommunication system of claim 1, wherein at least one of the at least one software system further comprises at least one of: a hypervisor; an operating system; a hardware driver software; a programming software; a test software; at least one software running virtual instance; a virtual machine software; a virtual machine load management software; a virtual machine resource usage monitoring software; a container software; a container resource usage monitoring software; a container load management software; a container orchestrator software; a resource management software; and a port management software.

4. The telecommunication system of claim 1, wherein the hardware system further comprises of at least one of: a memory unit; a central processing unit; a controller unit; a graphical processing unit; one or more ports; one or more hardware boards; one or more cables; and one or more converters; and any other hardware component.

5. The telecommunication system of claim 1, wherein the at least one virtual machine comprises a software system executing task or a set of tasks.

6. The telecommunication system of claim 1, wherein the at least one container further comprises a software system executing a task or a set of tasks.

7. The telecommunication system of claim 1, wherein the at least one virtual machine container scheduler further comprises a software system for executing a task or a set of tasks.

8. The telecommunication system of claim 1, wherein the at least one software instance scheduler further comprises a software system for executing task or a set of tasks.

9. A method of virtual machine container scheduling comprising:
analyzing a load level of at least a portion of at least one virtual machine and/or container instance;
analyzing at least one requirement of data transmission latency selected from: data throughput; data error rate; data service quality; data subscriber experience quality; data block error rate; and data security of at least a portion of functions of at least one data processing layer; and
selecting at least one of the at least one virtual machine and/or container to run at least one function of at least one data processing layer.

10. The method of claim 9, further comprising determining hardware and software resources consumed by at least one virtual machine and/or container software.

11. The method of claim 9, further comprising of determining energy resources consumed by at least one virtual machine and/or container software.

12. The method of claim 9, further comprising performing measuring and monitoring in a container software load consumption measurement and monitoring software, wherein the container software load consumption measurement and monitoring software is a portion of a container software system or is software other than the container software system.

13. The method of claim 9, further comprising performing measuring and monitoring in a virtual machine software load consumption measurement and monitoring software, wherein the virtual machine software load consumption measurement and monitoring software is a portion of a virtual machine software system or is software other than the virtual machine software system.

14. The method of claim 9, further comprising reading a layer information file comprising: a layer name; a layer number; a layer data transmission latency requirement; a layer data throughput requirement; a previously run container number; a previously run virtual machine number; an upper layer served by a layer, and a lower layer served by a layer.

15. The method of claim 9, further comprising analyzing inputs selected from: data processing layer information; virtual machine information; container information; virtual machine instances; container instances; technology; backhaul type; fronthaul type; location; hardware operating system; hypervisor; and priority table.

16. The method of claim 15, further comprising creating profiles for the at least one at least one virtual machine and/or container instance, within at least one of a container software and a virtual machine software, employing at least one of: running protocol layer information, resource consumption information, error information, quality of service information, data communication performance information, hardware performance information, and software performance information.

17. The method of claim 9; further comprising profiling performance of at least one container instance in at least one container software performance profiler.

18. The method of claim 9; further comprising profiling performance of at least one virtual machine instance in at least one virtual machine software performance profiler.

19. A method of software instance scheduling via a software instance scheduler comprising:
analyzing a load level of at least one of at least one virtual machine software and/or container software instance; and
selecting at least one most suitable virtual machine software and/or container software instances to execute at least a portion of one or more data processing layer functions.

20. The method of claim 19, further comprising: reading a virtual machine or container instance identification file comprising: a virtual machine or container instance name; a virtual machine or container instance identification number; identity of a layer processed in a virtual machine or container instance; an operating system type; an operating system release number; a resource usage; a performance; and a container type.
